(19) United States
(12) Patent Application Publication
(10) Pub. No.: US 2011/0051262 A1
(43) Pub. Date: Mar. 3, 2011

(54) WIDE-ANGLE LENS

(75) Inventor: Takuya Imaoka, Kanagawa (JP)

(73) Assignee: PANASONIC CORPORATION, Osaka (JP)

(21) Appl. No.: 12/863,859

(22) PCT Filed: May 27, 2009
(86) PCT No.: PCT/JP2009/002334

§ 371 Date: Jul. 21, 2010

(30) Foreign Application Priority Data
Feb. 3, 2009 (JP) 2009-022885

(51) Int. Cl. G02B 9/34

(52) U.S. Cl. 359/781

(57) ABSTRACT

A wide-angle lens (1) comprises: a first lens (2) placed on an object side; and a lens group (3) arranged closer to an image plane than the first lens (2). The first lens (2) is a resin-made meniscus lens: which has a convex surface on the object side; which has negative power; at least one surface of which is aspherical; whose refractive index at d line is equal to or greater than 1.58; whose Abbe number is equal to or less than 35; and on the convex surface on the object side of which is formed a hard coat layer (4). The lens group (3) comprises a plurality of lenses (a second lens (5), a third lens (6), and a fourth lens (8)) which have positive power in total. This provides a wide-angle lens that has a wide angle of view, is inexpensive, and is scratch proof.

### TECHNICAL FIELD

The present invention relates to a wide-angle lens comprising a lens group made of resin.

### BACKGROUND ART

A wide-angle lens used for an in-vehicle camera or the like is required to not only have a wide angle of view (e.g. an angle of view of 130 degrees or greater) but also be inexpensive and environmentally resistant (scratch proof). Wide-angle lenses comprising a lens group made of resin have previously been suggested as inexpensive wide-angle lenses whose angle of view is wide (e.g. see Patent Documents 1 to 3).

### PRIOR ART DOCUMENTS

### Patent Documents

Patent Document 1: Japanese Patent Laid-Open Application No. 2007-264676

Patent Document 2: Japanese Patent Laid-Open Application No. 2005-321742

Patent Document 3: Japanese Patent Laid-Open Application No. 2006-284620

Lenses of the conventional wide-angle lenses, however, would be susceptible to scratches and the like since their lens closest to the object is made of resin. Particularly, an in-vehicle camera exceptionally requires the lens to be environmentally resistant (scratch proof) as it tends to be used in an environment where the surface of the lens is exposed to the outside, but the conventional wide-angle lenses could hardly meet the requirement.

### SUMMARY OF THE INVENTION

### Problems to be Solved by the Invention

The invention has been made in the above-mentioned background. A purpose of the invention is to provide a wide-angle lens that has a wide angle of view, is inexpensive, and is scratch proof.

### Means for Solving the Problems

One aspect of the invention is a wide-angle lens, and the wide-angle lens comprises: a first lens placed on an object side; and a lens group arranged closer to an image plane than the first lens, where the first lens is a resin-made meniscus lens: which has a convex surface on the object side; which has negative power; at least one surface of which is aspherical; whose refractive index at d line is equal to or greater than a predetermined threshold refractive index; whose Abbe number is equal to or less than a predetermined threshold Abbe number; and on the convex surface on the object side of which is formed a hard coat layer, where the lens group comprises a plurality of lenses which have positive power in total, and where the threshold refractive index and the threshold Abbe number are set based on the degree of easiness of forming the hard coat layer on the convex surface made of resin.

There are other aspects of the invention as described below. This disclosure of the invention therefore intends to provide part of the aspects of the invention and does not intend to limit the scope of the invention described and claimed herein.

### BRIEF DESCRIPTION OF THE DRAWINGS

FIG. 1 is a cross section showing a configuration of a wide-angle lens of an embodiment;

FIG. 2 is an aberration curve diagram of the wide-angle lens of the embodiment;

FIG. 3 is an aberration curve diagram of the wide-angle lens of the embodiment; and

FIG. 4 is an aberration curve diagram of the wide-angle lens of the embodiment.

### MODE OF EMBODYING THE INVENTION

Now, the invention will be described in detail. However, the following detailed description and appended drawings are not intended to limit the invention. Rather, the scope of the invention is defined by the appended claims.

A wide-angle lens of the invention comprises: a first lens placed on an object side; and a lens group arranged closer to an image plane than the first lens, where the first lens is a resin-made meniscus lens: which has a convex surface on the object side; which has negative power; at least one surface of which is aspherical; whose refractive index at d line is equal to or greater than a predetermined threshold refractive index; whose Abbe number is equal to or less than a predetermined threshold Abbe number; and on the convex surface on the object side of which is formed a hard coat layer, where the lens group comprises a plurality of lenses which have positive power in total, and where the threshold refractive index and the threshold Abbe number are set based on the degree of easiness of forming the hard coat layer on the convex surface made of resin.

This configuration, with the refractive index (refractive index at d line) of the first lens raised to set its Abbe number low, allows the hard coat layer to be easily formed on the convex surface of the first lens. This hard coat layer protects the convex surface of the first lens, thus allowing the convex surface of the first lens on the object side to be scratch proof (environmentally resistant). In addition, the resin-made first lens can reduce the cost of manufacturing. The combination of the first lens having negative power and the lens group having positive power can widen the angle of view.

In the wide-angle lens of the invention, the lens group may comprise: a second lens made of resin and placed on the object side; a third lens made of resin and placed closer to the image plane than the second lens; a fourth lens made of resin and placed closer to the image plane than the third lens; and an aperture placed between the third lens and the fourth lens, the second lens may be a lens: which has negative power; at least one surface of which is aspherical; whose refractive index at d line is equal to or less than a predetermined maximum refractive index; and whose Abbe number is equal to or greater than a predetermined minimum Abbe number, the third lens may be a lens: which has positive power; at least one surface of which is aspherical; whose refractive index at d line is equal to or greater than a predetermined minimum refractive index; and whose Abbe number is equal to or less than a predetermined maximum Abbe number, the fourth lens may be a lens: which has positive power; at least one surface of which is aspherical; whose refractive index at d line is equal to or less than the maximum refractive index; and whose Abbe number is equal to or greater than the minimum Abbe number, and the maximum refractive index and minimum Abbe number and the minimum refractive index and maximum Abbe number may be set based on total chromatic aberration of magnification.

This configuration, with the refractive indices (refractive indices at d line) of the second and fourth lenses lowered to set their Abbe numbers high, and with the refractive index (refractive index at d line) of the third lens raised to set its Abbe number low, allows total chromatic aberration of magnification to be reduced even if the refractive index (refractive index at d line) of the first lens is raised to set its Abbe number low.

In the wide-angle lens of the invention, the threshold refractive index may be 1.58 and the threshold Abbe number may be 35.

This configuration, with the threshold refractive index for the first lens set to 1.58 and the threshold Abbe number for the first lens set to 35, allows the hard coat layer to be easily formed on the convex surface of the first lens.

In the wide-angle lens of the invention, the maximum refractive index may be 1.54 and the minimum Abbe number may be 55, and the minimum refractive index may be 1.58 and the maximum Abbe number may be 35.

This configuration, with the maximum refractive index for the second and fourth lenses set to 1.54 and the minimum Abbe number for second and fourth lenses set to 55, and with the minimum refractive index for the third lens set to 1.58 and the maximum Abbe number for the third lens set to 35, allows total chromatic aberration of magnification to be reduced even if the threshold refractive index for the first lens is set to 1.58 and the threshold Abbe number for the first lens is set to 35.

The invention can provide a wide-angle lens that has advantages of having a wide angle of view, being inexpensive, and being scratch proof.

Now, a wide-angle lens of an embodiment of the invention will be described with reference to the drawings. The embodiment illustrates a wide-angle lens that is used for an in-vehicle camera, a cell phone camera, a PC camera, a surveillance camera, or the like that uses an imaging device (CCD, CMOS, or the like).

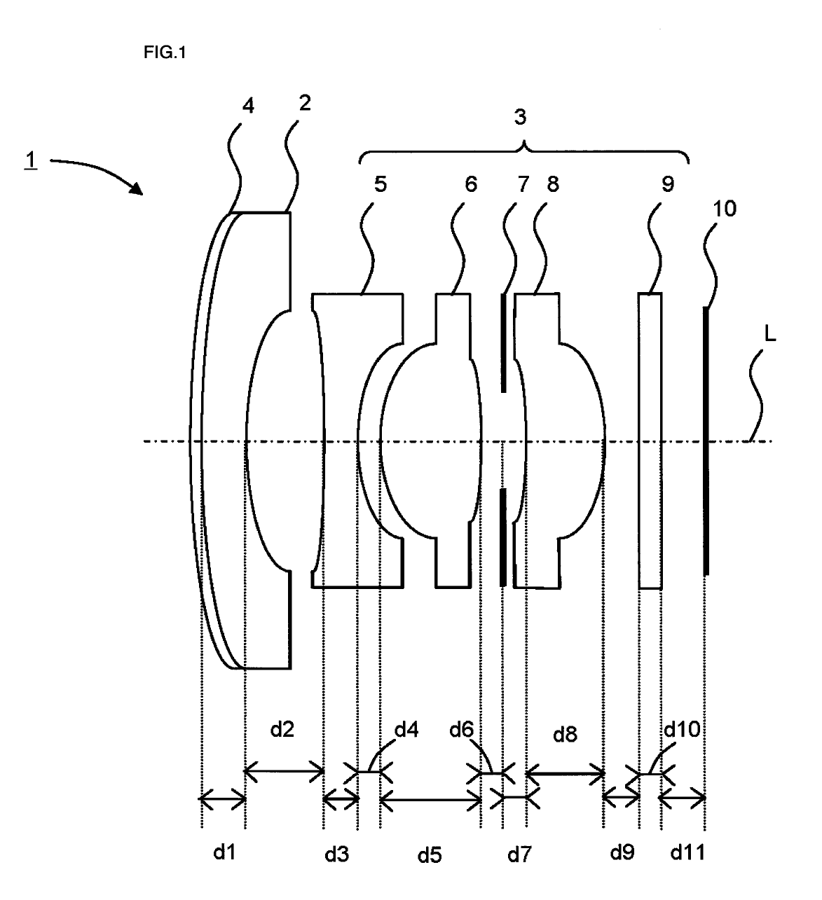

FIG. 1 is a cross section showing a configuration of a wide-angle lens of the embodiment. As shown in FIG. 1, a wide-angle lens 1 comprises: a first lens 2 placed on the object side (on the left in FIG. 1); and a lens group 3 arranged closer to an image plane than the first lens 2 (on the right in FIG. 1).

The first lens 2 is a resin-made meniscus lens: which has a convex surface on the object side; which has negative power; at least one surface of which is aspherical; whose refractive index at d line is equal to or greater than 1.58; and whose Abbe number is equal to or less than 35. Polycarbonate-based resin material, for example, is used as the material of the first lens 2. The properties of polycarbonate resins include a high refractive index at d line and a low Abbe number as compared to cyclo olefin polymer resins (e.g. ZEONEX (registered trademark)), which are commonly used as lens material. On the convex surface on the object side of the first lens 2 is formed a hard coat layer 4. Silicon-based coating material, for example, is used as the material of the hard coat layer 4. Silicon-based coating material goes well with polycarbonate resins. In this case, the refractive index (refractive index at d line) and Abbe number of the first lens 2 are set in consideration of ease of forming (the degree of easiness of forming) the hard coat layer 4 on the convex surface.

The lens group 3 comprises: a second lens 5 made of resin and placed on the object side; a third lens 6 made of resin and placed closer to the image plane than the second lens 5; and a fourth lens 8 made of resin and placed closer to the image plane than the third lens 6, and an aperture 7 is placed between the third lens 6 and the fourth lens 8.

The second lens 5 is a lens: which has negative power; at least one surface of which is aspherical; whose refractive index at d line is equal to or less than 1.54; and whose Abbe number is equal to or greater than 55. The third lens 6 is a lens: which has positive power; at least one surface of which is aspherical; whose refractive index at d line is equal to or greater than 1.58; and whose Abbe number is equal to or less than 35. The fourth lens 8 is a lens: which has positive power; at least one surface of which is aspherical; whose refractive index at d line is equal to or less than 1.54; and whose Abbe number is equal to or greater than 55. In this case, the refractive index (refractive index at d line) and Abbe number of the lens group 3 (the second lens 5, the third lens 6, and the fourth lens 8) are set in consideration of total chromatic aberration of magnification.

As shown in FIG. 1, a cover glass 9 and an imaging device 10 are arranged closer to the image plane than the wide-angle lens 1. The cover glass 9 has a function to seal the imaging device 10. The cover glass 9 also has a function as a filter that transmits light in a predetermined wavelength region (e.g. a low-pass filter). The imaging device 10 is, for example, a CCD or a CMOS.

### Example

Lens data of the wide-angle lens 1 of this working example is shown in Table 1 below.

TABLE 1
Lens Data

| | | | Distance | | |
|---|---|---|---|---|---|
| | Surface | Radius of | between | Refractive | Abbe |
| Surface | type | curvature | surfaces | index: nd | number: νd |
| S1 | Aspherical | 11.440 | 1.000 | 1.5825 | 30.18 |
| S2 | Aspherical | 4.540 | 2.364 | | |
| S3 | Aspherical | −23.642 | 0.600 | 1.5094 | 56.60 |
| S4 | Aspherical | 0.923 | 0.677 | | |
| S5 | Aspherical | 1.631 | 2.286 | 1.6142 | 25.59 |
| S6 | Aspherical | −6.965 | 0.523 | | |
| S7 | | | 0.276 | | |
| (Aperture) | | | | | |
| S8 | Aspherical | −15.401 | 2.424 | 1.5094 | 56.60 |
| S9 | Aspherical | −1.048 | 1.550 | | |
| S10 | | | 0.300 | | |
| S11 | | | 0.290 | | |

In this Table 1, Surface S1 is the surface on the object side of the first lens 2, and Surface S2 is the surface on the image plane side of the first lens 2. Surface S3 is the surface on the object side of the second lens 5, and Surface S4 is the surface on the image plane side of the second lens 5. Surface S5 is the surface on the object side of the third lens 6, and Surface S6 is the surface on the image plane side of the third lens 6. Surface S7 is the aperture 7. Surface S8 is the surface on the object side of the fourth lens 8, and Surface S9 is the surface on the image plane side of the fourth lens 8. Surface S10 is the surface on the object side of the cover glass 9, and Surface S11 is the surface on the image plane side of the cover glass 9. This data does not include the hard coat of the first lens 2, since it does not much affect the optical performance.

In Table 1, Surface type represents whether each surface is spherical or aspherical. If the surface is aspherical, the shape of the surface is expressed by the equation below, where the x-axis is coaxial with the optical axis L, the y-axis is perpendicular to the optical axis L, and the traveling direction of a light beam is the positive direction.

$$X = \frac{\frac{{Y}^{2}}{r}}{1 + \sqrt{\frac{1 - ( 1 + k ) {Y}^{2}}{{r}^{2}}}} + {A}_{1} {Y}^{4} + {A}_{2} {Y}^{6} + {A}_{3} {Y}^{8} + {A}_{4} {Y}^{10} \qquad [ Mathematical Expression 1 ]$$

In the above equation, r is the radius of curvature of the lens; and k is the conic constant of the aspherical surface. A₁ is the 4th order aspherical coefficient; A₂ is the 6th order aspherical coefficient; A₃ is the 8th order aspherical coefficient; and A₄ is the 10th order aspherical coefficient. The values of these aspherical coefficients are shown in Table 2 below.

TABLE 2
Aspherical coefficients

| | S1 | S2 | S3 | S4 |
|---|---|---|---|---|
| Conic constant (K) | −5.432E−01 | 6.838E−01 | 5.946E+01 | −8.402E−01 |
| 4th order coefficient (A) | −5.215E−04 | 1.003E−03 | 1.187E−03 | −5.051E−02 |
| 6th order coefficient (B) | −2.169E−06 | −8.100E−04 | −2.537E−04 | −3.288E−03 |
| 8th order coefficient (C) | 6.895E−08 | 1.213E−04 | 2.108E−07 | 2.569E−03 |
| 10th order coefficient (D) | 5.823E−09 | −7.062E−06 | 2.417E−06 | −7.200E−04 |
| | S5 | S6 | S8 | S9 |
| Conic constant (K) | −1.799E+00 | 0.000E+00 | 0.000E+00 | −2.328E+00 |
| 4th order coefficient (A) | 3.542E−02 | 1.940E−02 | −1.051E−01 | −1.207E−01 |
| 6th order coefficient (B) | −2.190E−03 | −1.210E−03 | 3.137E−01 | 6.540E−02 |
| 8th order coefficient (C) | 1.320E−03 | 1.850E−03 | −4.812E−01 | −2.953E−02 |
| 10th order coefficient (D) | −1.289E−04 | −3.210E−04 | 3.912E−01 | 6.489E−03 |

In Table 1, Radius of curvature is the reciprocal of the curvature of each surface, and surfaces without mention of Radius of curvature are planes. Distance between surfaces is the distance to the next surface. Refractive index is the refractive index at d line between the surface concerned and the next surface. Abbe number is the Abbe number at d line between the surface concerned and the next surface.

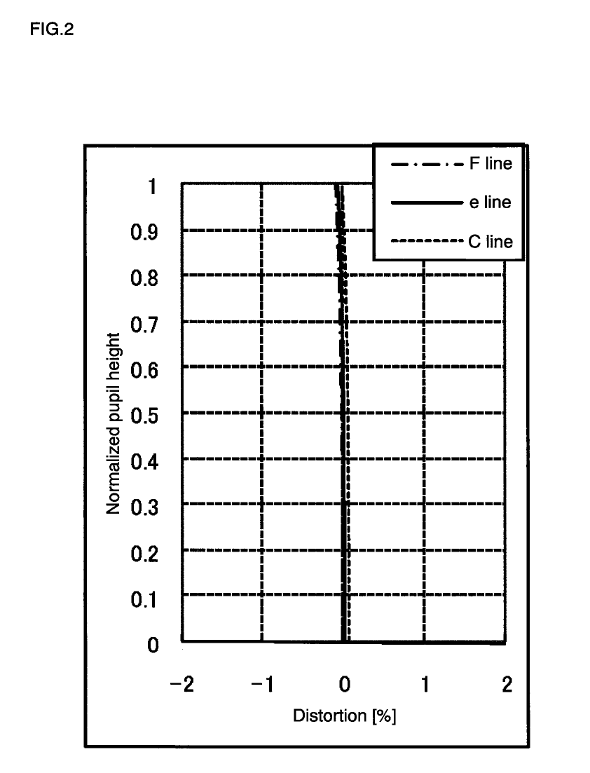

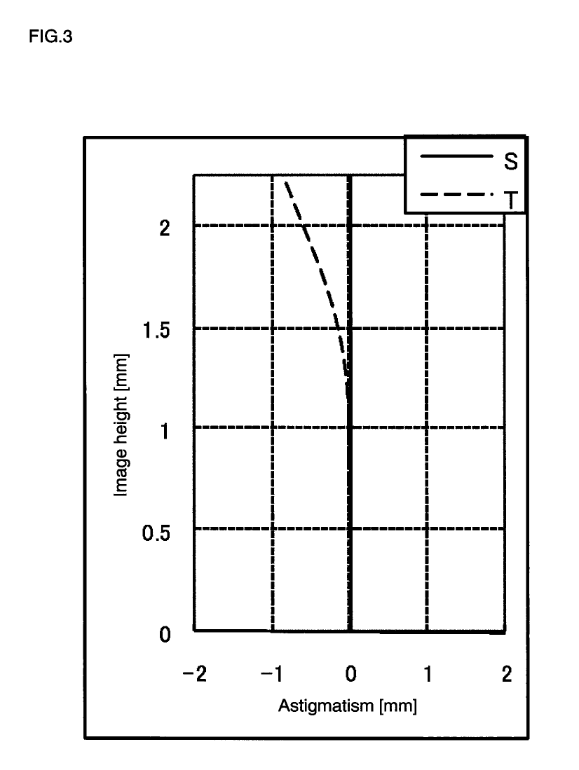

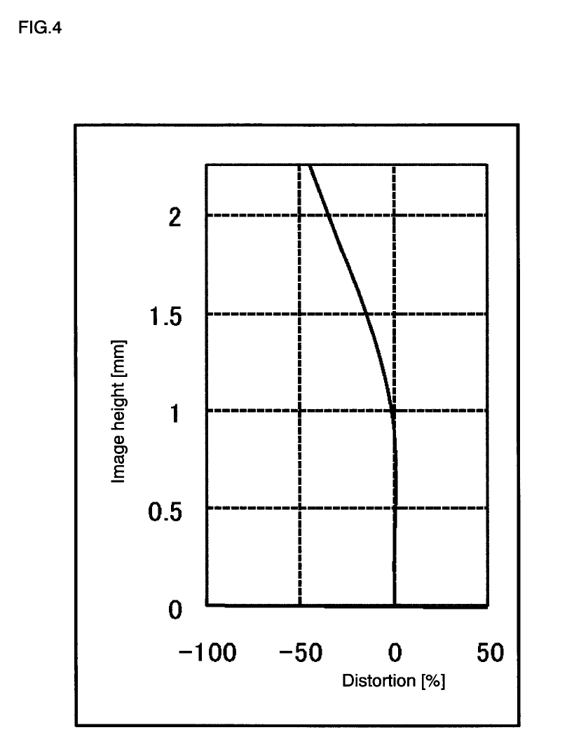

FIGS. 2 to 4 are aberration curve diagrams of the wide-angle lens 1 of the working example. FIG. 2 is a curve diagram of distortion versus the normalized pupil height. FIG. 3 is a curve diagram of astigmatism versus the image height, and FIG. 4 is a curve diagram of distortion versus the image height.

Numerical data of the wide-angle lens 1 of the embodiment is shown in Table 3 below.

TABLE 3

| F number | 2.8 | |
|---|---|---|
| Focal length (f) | 1.14 | mm |
| Diagonal length of the sensor (D) | 4.50 | mm |
| Angle of view (2ω) | 149° | |
| Back focus (in glass) | 2.14 | mm |
| Distortion (D) | −44.6% | |
| Chromatic aberration of magnification (60%: C-e) | −4.1 | μm |
| Chromatic aberration of magnification (60%: F-e) | 4.1 | μm |

In this Table 3, Angle of view (2ω) is the angle of view at a diagonal point of the sensor. Back focus (in glass) is the distance from the second surface of the third lens 6 to the sensor surface, between which is placed the cover glass 9 of 0.3 mm. Distortion (D) is distortion at a diagonal point of the sensor. Chromatic aberration of magnification (60%: C-e) is deviation of a principal ray of C line on the image plane in a direction perpendicular to the optical axis L with reference to e line at a 60% point to a diagonal point of the sensor. Chromatic aberration of magnification (60%: F-e) is deviation of a principal ray of F line on the image plane in a direction perpendicular to the optical axis L with reference to e line at a 60% point to a diagonal point of the sensor.

The embodiment described above can provide the wide-angle lens 1 which has a wide angle of view, is inexpensive, and is scratch proof.

That is, the embodiment, with the refractive index (refractive index at d line) of the first lens 2 raised to set its Abbe number low, allows the hard coat layer 4 to be easily formed on the convex surface of the first lens 2. This hard coat layer 4 protects the convex surface of the first lens 2, thus allowing the convex surface of the first lens 2 on the object side to be scratch proof (environmentally resistant). In addition, the resin-made first lens 2 can reduce the cost of manufacturing. The combination of the first lens 2 having negative power and the lens group 3 having positive power can widen the angle of view.

Specifically, the threshold refractive index for the first lens 2 set to 1.58 and the threshold Abbe number for the first lens 2 set to 35 allow the hard coat layer 4 to be easily formed on the convex surface of the first lens 2.

In the embodiment, the lens group 3 corrects chromatic aberration of magnification well. That is, with the refractive indices (refractive indices at d line) of the second lens 5 and fourth lens 8 lowered to set their Abbe numbers high, and with the refractive index (refractive index at d line) of the third lens 6 raised to set its Abbe number low, total chromatic aberration of magnification can be reduced even if the refractive index (refractive index at d line) of the first lens 2 is raised to set its Abbe number low.

Specifically, with the maximum refractive index for the second lens 5 and fourth lens 8 set to 1.54 and the minimum Abbe number for the second lens 5 and fourth lens 8 set to 55, and with the minimum refractive index for the third lens 6 set to 1.58 and the maximum Abbe number for the third lens 6 set to 35, total chromatic aberration of magnification can be reduced even if the threshold refractive index for the first lens 2 is set to 1.58 and the threshold Abbe number for the first lens 2 is set to 35.

While there has been described an embodiment of the invention with reference to illustrations, the scope of the invention is not limited thereto, and modifications and variations may be made thereto within the claimed scope according to purposes.

While there has been described what is at present considered to be a preferred embodiment of the invention, it will be understood that various modifications and variations may be made thereto, and it is intended that appended claims cover all such modifications and variations as fall within the true spirit and scope of the invention.

### INDUSTRIAL APPLICABILITY

As stated above, the wide-angle lens according to the invention has advantages of having a wide angle of view, being inexpensive, and being scratch proof, and is useful as it is used for an in-vehicle camera, a cell phone camera, a PC camera, a surveillance camera, or the like that uses an imaging device (CCD, CMOS, or the like).

### DESCRIPTION OF THE SYMBOLS

1: Wide-angle lens
2: First lens
3: Lens group
4: Hard coat layer
5: Second lens
6: Third lens
7: Aperture
8: Fourth lens
9: Cover glass
10: Imaging device
L: Optical axis

1. A wide-angle lens comprising: a first lens placed on an object side; and a lens group arranged closer to an image plane than the first lens, wherein
the first lens is a resin-made meniscus lens: which has a convex surface on the object side; which has negative power; at least one surface of which is aspherical; whose refractive index at d line is equal to or greater than a predetermined threshold refractive index; whose Abbe number is equal to or less than a predetermined threshold Abbe number; and on the convex surface on the object side of which is formed a hard coat layer, wherein
the lens group comprises a plurality of lenses which have positive power in total, and wherein
the threshold refractive index and the threshold Abbe number are set based on the degree of easiness of forming the hard coat layer on the convex surface made of resin.

2. The wide-angle lens according to claim 1, wherein
the lens group comprises: a second lens made of resin and placed on the object side; a third lens made of resin and placed closer to the image plane than the second lens; and a fourth lens made of resin and placed closer to the image plane than the third lens, and an aperture is placed between the third lens and the fourth lens, wherein
the second lens is a lens: which has negative power; at least one surface of which is aspherical; whose refractive index at d line is equal to or less than a predetermined maximum refractive index; and whose Abbe number is equal to or greater than a predetermined minimum Abbe number, wherein
the third lens is a lens: which has positive power; at least one surface of which is aspherical; whose refractive index at d line is equal to or greater than a predetermined minimum refractive index; and whose Abbe number is equal to or less than a predetermined maximum Abbe number, wherein
the fourth lens is a lens: which has positive power; at least one surface of which is aspherical; whose refractive index at d line is equal to or less than the maximum refractive index; and whose Abbe number is equal to or greater than the minimum Abbe number, and wherein
the maximum refractive index and minimum Abbe number and the minimum refractive index and maximum Abbe number are set based on total chromatic aberration of magnification.

3. The wide-angle lens according to claim 1, wherein the threshold refractive index is 1.58 and the threshold Abbe number is 35.

4. The wide-angle lens according to claim 2, wherein the maximum refractive index is 1.54 and the minimum Abbe number is 55, and wherein the minimum refractive index is 1.58 and the maximum Abbe number is 35.
